(19) United States
(12) Patent Application Publication
(10) Pub. No.: US 2012/0092673 A1
(43) Pub. Date: Apr. 19, 2012

(54) DEVICE AND METHOD FOR OPTICALLY DETECTING GAS

(76) Inventor: Marinus Johannes Slaman, Waddinxveen (NL)

(21) Appl. No.: 13/260,172

(22) PCT Filed: Apr. 12, 2010
(86) PCT No.: PCT/NL2010/050190

§ 371 Date: Dec. 16, 2011

(30) Foreign Application Priority Data
Apr. 10, 2009 (NL) 2002744

(51) Int. Cl. G01N 21/55

(52) U.S. Cl. 356/445

(57) ABSTRACT

A device for optically detecting fluid comprises several optical fibres, each of which is provided with a sensor end and an opposite coupling end. Each of the sensor ends is provided with an optical sensor having reflective properties which depend on the concentration of the fluid to be detected at the sensor. The device comprises a light source, a detector and an optical body. The coupling ends of the optical fibres are connected to the optical body at a distance from one another. The light source and the detector are arranged on the optical body in such a manner that light is conducted from the light source through the optical body and is coupled at the coupling ends of the optical fibres and light which is reflected by the optical sensor and which is ejected from the coupling ends of the optical fibres is conducted through the optical body and is received by the detector. The distance between the coupling ends of the optical fibres is such that the ejected light from each coupling end can be detected separately.

The invention relates to a device for optically detecting fluid, comprising several optical fibres, each of which is provided with a sensor end and an opposite coupling end, wherein each of the sensor ends is provided with an optical sensor having reflective properties which depend on a property of the fluid to be detected at the sensor, such as the concentration thereof, a light source and a detector.

As referred to in the context of the present patent application, the expression optically detecting fluid is understood to mean detecting an optical change (in reflectivity) at the sensor end of the optical fibres as a result of a change in a property of the fluid to be detected. This property of the fluid is, for example, the concentration of the fluid, for example in order to detect the presence of such fluid. However, this property of the fluid can also be the pH value of the fluid or the temperature of the fluid. The device can, for example, be used for detecting hydrogen gas which is released, for example, during reactions in an electrolyte or for detecting hydrocarbon compounds in water or alcohol, etc. The optical sensors can be used in a fluid (liquid and/or gas) for detecting fluid (liquid and/or gas).

Further applications are the detection of different compounds/elements with each sensor.

NL1030299 discloses a hydrogen sensor which is provided with an optical switching device, whose reflective properties depend on the amount of hydrogen which is present in the space in which the optical switching device is arranged. The optical switching device is connected to a light source and a detector via optical fibres and a bifurcator. The detector detects changes in the reflective properties of the optical switching device, from which the hydrogen concentration can be deduced. The detector can be connected to a number of optical fibres which are connected to optical switching devices situated in the same space or in different areas. In this case, however, the optical switching devices are read successively by the detector, which is time-consuming.

U.S. Pat. No. 5,320,814 describes, with reference to FIG. 22, an optical system for determining the properties of a colorant. This colorant is held in a container which contains the sensor ends of a series of fibres, each of which can detect a specific property. Light is introduced into the sample container via the fibres and the resulting emitted signal is conducted to a photo-sensitive detector, such as a camera, for further processing.

It is an object of the invention to provide an optical device which can readily read several gas indicators simultaneously.

It is a further object of the present invention to provide an optical device which can be used for general fluid determination, such as for liquids.

This object is achieved according to the invention in that the device comprises an optical body, and the coupling ends of the optical fibres are connected to the optical body at a distance from one another, and the light source and the detector are arranged on the optical body in such a manner that light is conducted from the light source through the optical body and is entered at the coupling ends of the optical fibres and light which is reflected by the optical sensor and which is ejected from the coupling ends of the optical fibres is conducted through the optical body and is received by the detector, and the distance between the coupling ends of the optical fibres is such that the ejected light from each coupling end can be detected separately. Due to the embodiment of the optical body with the spaced-apart coupling ends of the optical fibres, it is possible to easily read different optical sensors simultaneously. Such an optical body has to be distinguished from a beam splitter known from the prior art in which a path for the light beam incident on the fibres and a path for the egressing light bundle for the fibres can be distinguished. Such a beam splitter uses mirrors and the like. The present invention involves a single “field of view”, into which and from which the light is entered and ejected, respectively.

A further advantage is the fact that the costs and susceptibility to failure are lower due to the fact that several optical fibres are coupled simultaneously to a single light source and a single detector. In addition, the installation and maintenance costs are relatively low due to the fact that the number of parts is limited and the alignment and calibration can be carried out in a simple manner.

In one embodiment, the coupling ends of the optical fibres are connected to the optical body in accordance with a grid, in which the detector is provided with an image plane for receiving the ejected light from each coupling end according to a grid of points of light which corresponds to the grid of the coupling ends. The grid is for example square or rectangular, so that the grid of points of light is also formed by a square or rectangular grid. If a point of light is not present, or is only present to a reduced degree, in this grid of points of light, this means that the sensor of the associated optical fibre has not reflected any light or has only reflected insufficient light. This gives information about the concentration of fluid which is present at the location of such sensor.

Such a grid is specific, that is to say that if, for example, the sensor ends being moved relative to the optical body can result in a displacement of the “image” produced by the optical fibres on the optical body, but the structure of the grid nonetheless remains intact. This means that if for example a camera is used to detect the image, this camera can register such a displacement, as a result of which the correct reading of each of the signals on the sensors is ensured.

It is possible for a first optical sensor to have reflective properties which depend on the concentration of a first fluid, and in which a second optical sensor has reflective properties which depend on the concentration of a second fluid which differs from the first fluid. Each of the sensors may then be embodied for detecting in each time a different fluid, so that a fluid composition can be measured, such as a gas composition of a gas mixture.

More particularly, according to the present invention, the intensity (change in intensity) at an optical fibre is determined. This means that, in principle, it is not the change in colour which is observed but only which portion of the amount of light introduced is returned at a specific optical fibre.

In one embodiment, a first optical sensor is arranged at a first location, with a second optical sensor being arranged at a second location. This makes it possible to detect fluid concentrations at different locations. For example, the sensors may be embodied as hydrogen sensors and these hydrogen sensors may be arranged at different locations in a hydrogen car. As a result thereof, it is readily possible to simultaneously detect hydrogen at these multiple locations. The expression different locations is understood to mean that there is a considerable distance between the sensors and that they do not abut one another. Such a distance is at least a few centimetres.

In a first embodiment, a first sensor has reflective properties which change at a first concentration of a fluid, with a second sensor having reflective properties which change at a second concentration of the same fluid, which differs from the first concentration. Each of the sensors is configured for detecting different concentrations of the same fluid. Thus, it is possible to discover the magnitude of the concentration and the speed at which this increases or decreases.

In one embodiment, the coupling ends of the optical fibres are situated in a common coupling end plane where light can be entered into and can be ejected from said coupling ends. The coupling ends of the optical fibres determine a straight coupling end plane. The light beams which are ejected from the different coupling ends run substantially parallel to one another. This makes it possible to trace the image of points of light detected at the detector back in a simple manner to an associated optical sensor.

The optical body can be embodied in different ways. The coupling end plane is situated, for example, on a side of the optical body, while the light source and the detector are situated on a light-transmitting side of the optical body opposite said coupling end plane.

In one embodiment, the optical body has a first light-transmitting surface which extends at a first angle with respect to the coupling end plane, in which the light source is arranged on the first light-transmitting surface, and in which the optical body has a second light-transmitting surface which extends at a second angle with respect to the coupling end plane, and wherein the detector is arranged on the second light-transmitting surface. Thus, the light of the light source can illuminate the coupling ends of the optical fibres sufficiently intensely, while the light ejected from the coupling ends is also readily visible to the detector. In this embodiment, the field of view is divided into two adjoining parts, with one part serving for injecting light and the other for detecting.

Preferably, the first angle and/or the second angle is smaller than 35°. The angle between the light-transmitting surfaces of the light source and the detector is in this case, for example, 110° or more. If the first angle is smaller than 35°, this may lead to shadows at the coupling end plane. Coupling ends of optical fibres which are closer to the light source will inject more light, while coupling ends of optical fibres which are furthest from the light source possibly do not enter any more light due to the fact that they are situated in the plane of the shadow. If the second angle is smaller than 35°, the detector may possibly not receive any more light from the coupling ends which are furthest from the detector and may receive more light from the coupling ends which are closer to the detector. In order to prevent coupling ends from ending up in the shadow, the coupling ends can be arranged closer to the centre of the coupling end plane.

In one embodiment, the optical body has a straight light-transmitting surface which extends substantially parallel to the coupling end plane, with the light source being arranged on a first part of said light-transmitting surface and the detector being arranged on a second part of said light-transmitting surface. As a result thereof, a relatively large amount of light can be entered and ejected.

Therein it is possible for the light source on the first part of the light-transmitting surface to surround the detector on the second part of the light-transmitting surface. Therein the detector is situated within the light source and substantially directly opposite the coupling end plane where light is entered and ejected. With this variant as well, the field of view is divided, for example into an annular part situated on the outer circumference into which the light is introduced and a central detector part.

In one embodiment, the optical body comprises a light-transmitting material, such as glass or polycarbonate, in which the optical body is delimited by surfaces which are covered with a light-absorbing coating, except for at least the light-transmitting surface or the light-transmitting surfaces. This makes it impossible for light to escape from the optical body in an uncontrolled manner, except via the surfaces which are intended for this purpose where the light source and the detector are arranged. Instead of polycarbonate, any other optically suitable material can be used and it is in principle possible to use a gas for this purpose. Preferably, the body is provided with a dark side in the direction in which the ends of the fibres are observed in order to increase the contrast.

The coupling ends of the optical fibres may be connected to the optical body in different ways. For example, holes are provided in the optical body for receiving in each case one coupling end of each optical fibre. The holes are preferably filled with so-called “index matching fluid” in order to improve the detection accuracy. Alternatively, the optical body may comprise several bodies which are placed against one another. The optical fibres, for example, extend through a first body up to a contact surface which is provided against the second body. In between, “index matching fluid” may be provided.

It is possible for the optical fibres from the coupling ends to be arranged substantially parallel to one another and at a distance from one another in the optical body. Thus, the coupling ends can be placed in a grid which produces a readily recognizable image at the detector.

In one embodiment, the device is provided with an image recognition device for automatically recognizing the image, received by the detector, of the coupling ends which do or do not eject light reflected by the sensor. As a result thereof, a quick and reliable detection without human intervention is possible.

The invention also relates to a method for optically detecting fluid, comprising:
providing a device comprising several optical fibres, each of which is provided with a sensor end and an opposite coupling end, wherein each of the sensor ends is provided with an optical sensor having reflective properties which depend on a property of the fluid to be detected at the sensor, such as the concentration thereof, a light source, a detector, as well as an optical body, in which the coupling ends of the optical fibres are connected to the optical body at a distance from one another,
conducting light from the light source through the optical body to the coupling ends and coupling said light at the coupling ends,
conducting the coupled light from the coupling ends through the optical fibres to the sensors at the sensor ends,
reflecting amounts of light through the sensors to the sensor ends which depend on said property of the fluid to be detected at the location of the sensors,
conducting the reflected light from the sensor ends through the optical fibres back to the coupling ends,
ejecting the reflected light from the coupling ends and conducting said reflected, ejected light from the coupling ends through the optical body to the detector and said light being received by the detector,
separately detecting the reflected, ejected light from different coupling ends which are situated at a distance from one another.

Therein it is possible for the coupling ends of the optical fibres to be connected to the optical body in accordance with a pattern, with the detector receiving the ejected light from each coupling end in an image plane according to a pattern of points of light which corresponds to the pattern of the coupling ends.

There are different applications of the method. For example, it is possible for the optical sensors to detect different kinds of fluid (liquids and/or gases) or for the optical sensors to detect concentrations at different locations or for the optical sensors to detect different concentrations of the same fluid.

The image, received by the detector, of the coupling ends which do or do not eject light reflected by the sensor can be automatically recognized by means of image recognition.

The invention will now be explained in more detail with reference to the attached drawing, in which:

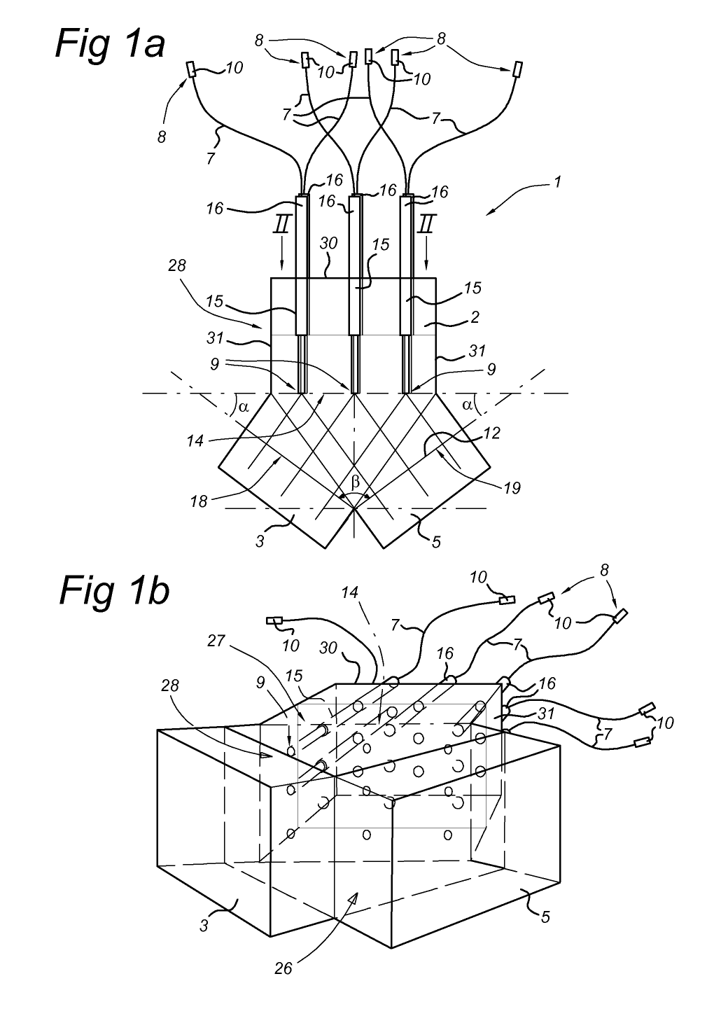

FIG. 1a shows a top view of a first embodiment of a device for optically detecting fluid;

FIG. 1b shows a view in perspective of the device shown in FIG. 1a;

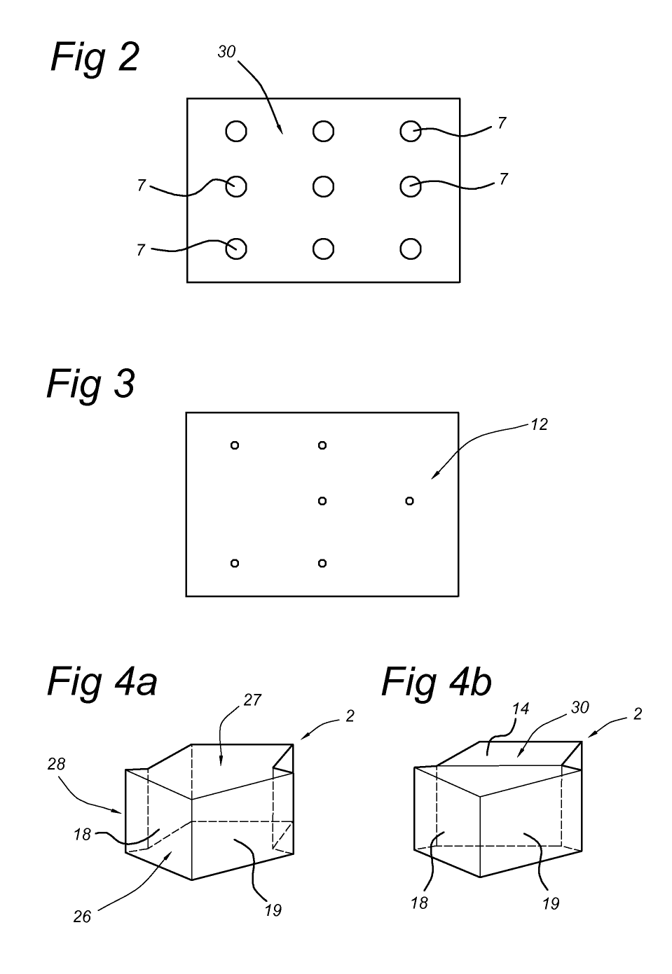

FIG. 2 shows a rear view according to II in FIG. 1a;

FIG. 3 shows an image which is observed by the detector of the device shown in FIGS. 1a,1b;

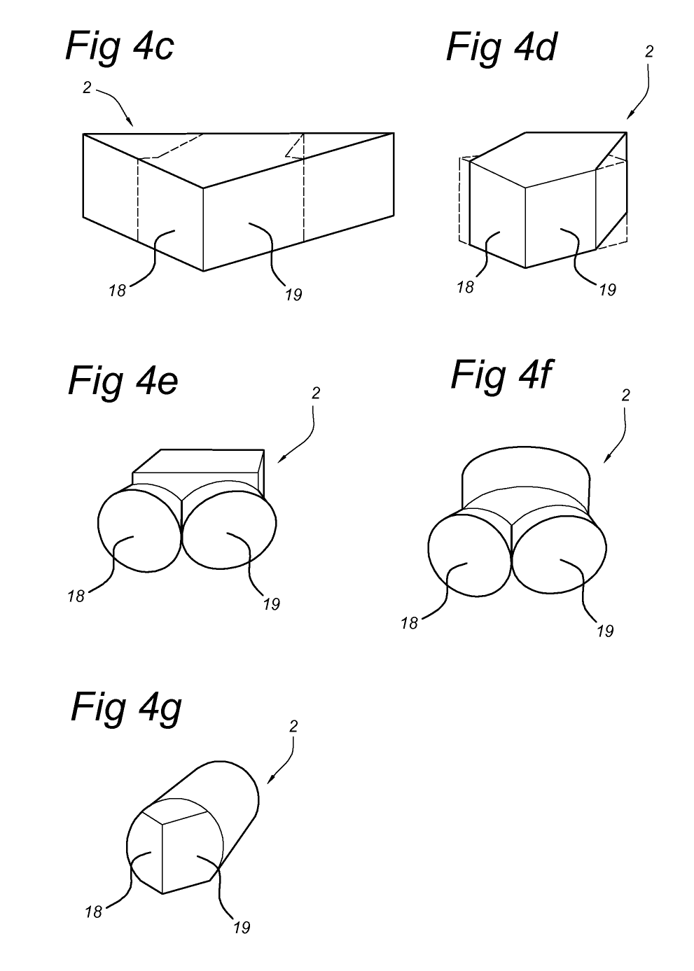

FIGS. 4a-4g show different embodiments of an optical body for use with the device shown in FIGS. 1a,1b;

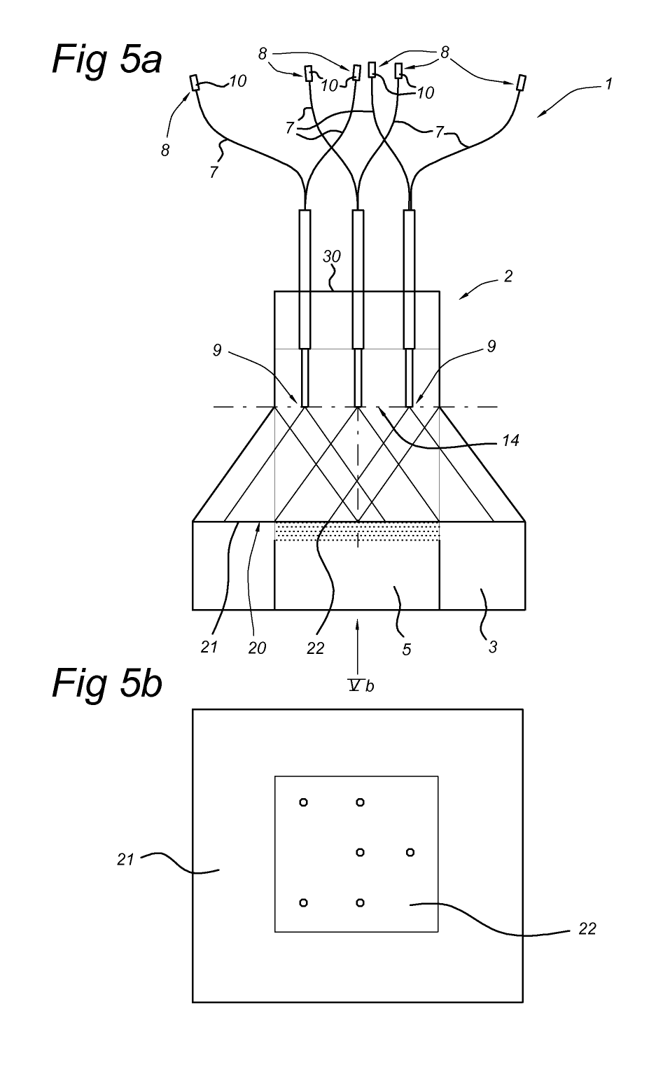

FIG. 5a shows a top view of a second embodiment of a device for optically detecting fluid.

FIG. 5b shows a front view according to Vb in FIG. 5a.

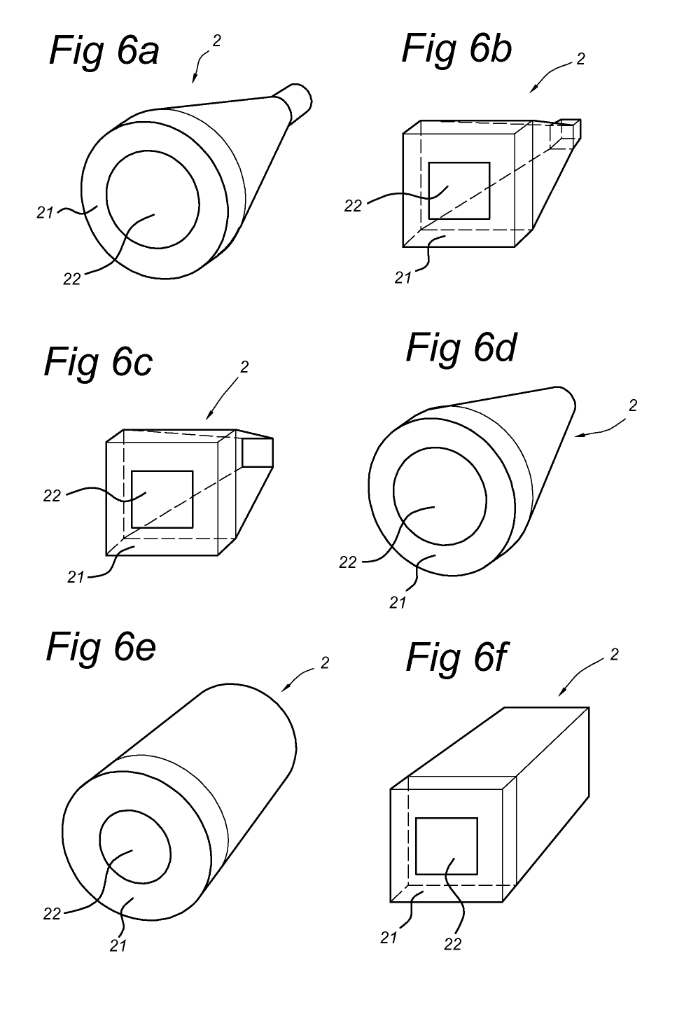

FIGS. 6a-6f show different embodiments of an optical body for use with the device shown in FIG. 5a.

The device for optically detecting a fluid is denoted overall in the drawing by reference numeral 1. The device 1 comprises several optical sensors 10. Although in this exemplary embodiment the device 1 has nine optical sensors 10, more or fewer sensors 10 may be provided. Each optical sensor 10 has reflective properties which depend on the concentration of fluid which is present at the location of the sensor 10. Such a sensor 10 is generally known in the prior art. The sensors 10 can be used in a liquid or gas in order to detect liquid or gas. In this exemplary embodiment, the device is embodied for optically detecting a gas.

In this exemplary embodiment, each of the sensors 10 is embodied for detecting a different gas. For example, a first sensor 10 comprises a layer sensitive to hydrogen so that the reflective properties thereof change when a variation in the hydrogen concentration around the first sensor 10 occurs, while a second sensor 10 comprises a layer sensitive to carbon monoxide so that the reflective properties thereof change when a variation in the carbon monoxide concentration around said second sensor 10 occurs. Instead of layers sensitive to hydrogen and carbon monoxide, the first and/or second sensor 10 may comprise layers sensitive to other gases, such as carbon dioxide, methane, oxygen, ammonia or alcohol. It is also possible for further sensors 10 to be embodied for detecting in each case different gases, for example one of the aforementioned gases or other gases.

Instead thereof, the sensors 10 may be embodied for detecting the same gas, that is to say each sensor 10 comprises a layer sensitive to the same gas so that the reflective properties change upon a variation in the concentration of said gas around the sensor 10. If the sensors 10 are arranged in different locations, the gas concentrations at these different locations are detected. For example, different locations can be checked for the presence of hydrogen.

In a particular embodiment, the sensors 10 are each provided with different sensitive layers, each of which react at a different amount of the same gas. By comparing the signals of the sensors 10 to one another, it is possible to find out the absolute gas concentration. It is also possible to detect an increase or a decrease in the gas concentration.

Each optical sensor 10 is arranged at a free end 8 (sensor end 8) of an optical fibre 7. Each optical fibre 7 extends from the sensor end 8 up to an coupling end 9. Each optical fibre 7 can transmit light from the coupling end 9 to the optical sensor 10 at the sensor end 8. The light reflected by the optical sensor 10 which depends on the gas concentration around the sensor 10, is conducted back to the coupling end 9 via the same optical fibre 7.

The coupling ends 9 of the optical fibres 7 are connected to an optical body 2 according to a pattern. In this exemplary embodiment, the pattern is formed by 3×3 optical fibres 7 (see FIG. 2). The coupling ends 9 are situated at a distance from one another in the pattern.

The optical body 2 is made from a light-transmitting material, for example glass or a transparent plastic, such as polycarbonate. The optical body 2 is substantially block-shaped. The optical body 2 is delimited by a lower surface 26, an upper surface 27 and a peripheral surface 28. In this exemplary embodiment, the peripheral surface 28 comprises two lateral surfaces 31, a rear surface 30 and two front surfaces 18,19. The two front surfaces 18,19 form two light-transmitting surfaces 18,19. The other surfaces 26,27,30,31 of the optical body 2 are provided with a light-absorbing coating, such as dark or black paint.

In this exemplary embodiment, the optical fibres 7 are arranged in the rear surface 30 of the optical body 5. The coupling ends 9 of the optical fibres 7 are situated in a common coupling end plane 14, that is to say the coupling end plane 14 is a straight plane which is defined by the coupling ends 9 of the optical fibres 7.

The coupling ends 9 of the optical fibres 7 may be fixed in the common coupling end plane 14 in different ways. In this exemplary embodiment, a number of holes 15 are arranged in the rear surface 30 of the optical body 5. One optical fibre 7 is provided in each hole 15. The holes 15 are filled with “index matching fluid”.

A protective plastic sleeve 16 is fitted around the optical fibres 7, which is only partially shown in FIG. 1a. In this exemplary embodiment, the protective plastic sleeve 16 is removed from the coupling ends 9 along an end part of the optical fibres 7 in order to ensure a good optical coupling between the coupling ends 9 and the “index matching fluid”. The holes 15 have a part which has a relatively narrow diameter for receiving the end parts of the optical fibres 7 without protective plastic sleeve 16. As a result thereof, less “index matching fluid” is required. In order to reinforce the optical fibres 7 when they are fastened to the optical body 2, the optical fibres 7 can also be provided there with a reinforcing sleeve which surrounds the protective plastic sleeve 16 (not shown).

A light source 3 is provided on the first light-transmitting surface 18 of the optical body 2. In this exemplary embodiment, the light source 3 is homogeneous. The homogeneous light source 3 produces, for example, a diffuse light plane at the first light-transmitting surface 18. A detector 5 is arranged on the second light-transmitting surface 19. The detector 5 is, for example, designed as a two-dimensional camera, for example a CCD camera or CMOS camera. The detector 5 is optionally provided with a lens for focusing on the coupling end plane 14.

In this exemplary embodiment, the angle α between the light-transmitting surfaces 18,19 and the coupling end plane 14 is approximately 35°. As a result thereof, the light source 3 can illuminate all coupling ends 9 arranged at a distance from one another, while all coupling ends 9 are also visible to the detector 5. The light-transmitting surfaces 18,19 enclose an angle β of approximately 110°.

The operation of the device 1 for optically detecting gas is as follows. The homogeneous light source 3 produces light which is conducted through the optical body 2 and coupled at the coupling ends 9 of the optical fibres 7. The optical fibres 7 conduct the entered light from the coupling ends 9 to the sensors 10 at the sensor ends 8. Depending on the amount of gas which is present around the sensors 10, the light is optionally reflected to a greater or lesser degree by the sensors 10. At a sufficiently low gas concentration, the sensor 10 reflects the light back through the optical fibres 7 to the coupling ends 9. Subsequently, the reflected light is ejected from the coupling ends 9 and conducted to the detector 5 via the optical body 2. The detector 5 thus receives an image of the coupling end plane 14, in which the coupling ends 9 do or do not produce a spot of reflected light. As the coupling ends 9 are situated at a distance from one another, the reflected light from different coupling ends 9 can be detected separately.

One example of an image of the coupling end plane 14 received by the detector 5 is represented in FIG. 3. If all sensors 10 reflect light, a 3×3 pattern of points of light would be visible. However, in the image of the 3×3 pattern of the coupling ends illustrated in FIG. 3, the points of light at the centre-left, upper right and lower right are missing. It follows from this that the corresponding sensors 10 have detected an increased gas concentration, so that no or insufficient light is reflected. Using the device 1 for detecting a gas, it is therefore possible to read several gas sensors simultaneously.

The image of the coupling end plane 14 can be analysed automatically by image recognition software. As a result thereof, the automatic reading of the different sensors 10 can be carried out in a simple and quick manner.

The shape of the block-shaped optical body 2 can be realised in different ways. Examples of the block-shaped optical body 2 are illustrated in FIGS. 4a-4g. In FIG. 4a, the optical body 2 is produced in one piece, while the optical body 2 from FIG. 4b is made in two pieces. The rear part is for example a block-shaped body of black material, through which the optical fibres 7 protrude. The coupling end plane 14 corresponds to the boundary surface between the two parts.

FIG. 4c shows an optical body 2 which operates in the same way as the optical body according to FIG. 4a, but in which the production is simpler. FIG. 4d shows an embodiment without protruding corners. In this case, the coupling ends of the optical fibres are arranged closer together, if desired, to prevent the coupling ends from coming to lie in the shadow. FIGS. 4e-4g show embodiments of the optical body 2 having round shapes.

FIG. 5a shows a second embodiment of the device for detecting a fluid, in which identical reference numerals have been used for the same or similar parts. This embodiment only differs from the embodiment shown in FIG. 1 in that the optical body 2 only has one light-transmitting front surface 20. The light-transmitting front surface 20 comprises two parts 21, 22 (see FIG. 5b). The detector 5 is arranged in the central part 22, while the homogeneous light source 3 is arranged on the part 21 which surrounds the central part 22 and the detector. In this embodiment, the light of the homogeneous (annular) light source 3 is incident upon the free ends or coupling ends 9 of the optical fibres 7 which are spaced apart. These coupling ends also transmit a signal emanating from the fibres from the sensors 10 which can be detected by detector 5. No ancillary optical means, such as beam splitters, mirrors or the like, are present in the space between the detector 5 and light source 3, respectively. FIGS. 6a-6f show that the optical body 2 can in this case also be designed in different ways.

The invention is not limited to the embodiments illustrated in the drawing. Those skilled in the art can think of various modifications which are within the scope of the invention. The detector may, for example, also be embodied in the form of a so-called “line array” or “2D array” CCD detector, such as a webcam, in which for example several pixels are available per coupling end 9.

1-23. (canceled)

24. A device for optically detecting fluid, comprising:
(a) optical fibres, each of which is provided with
(i) a sensor end comprising an optical sensor having reflective properties which depend on a property of the fluid to be detected at the sensor and
(ii) a coupling end,
(b) a light source,
(c) a detector, and
(d) an optical body,
wherein the coupling ends of the optical fibres are connected to the optical body at a distance from one another,
wherein the light source and the detector are arranged on the optical body such that light is conducted from the light source through the optical body and enters at the coupling ends of the optical fibres and light which is reflected by the optical sensors and which is ejected from the coupling ends of the optical fibres is conducted through the optical body and is received by the detector,
wherein the distance between the coupling ends of the optical fibres is such that the ejected light from each coupling end can be detected separately,
wherein the optical body has a first light-transmitting surface which extends at a first angle with respect to the coupling end plane, and
wherein the light source is arranged on the first light-transmitting surface,
wherein the optical body has a second light-transmitting surface which extends at a second angle with respect to the coupling end plane, and
wherein the detector is arranged on the second light-transmitting surface, and
wherein the first angle and/or the second angle is smaller than 35°.

25. The device of claim 24, wherein the coupling ends of the optical fibres are connected to the optical body in a pattern, and wherein the detector is provided with an image plane for receiving the ejected light from each coupling end according to a pattern of points of light which corresponds to the pattern of the coupling ends.

26. The device of claim 24, wherein a first optical sensor has reflective properties which depend on the concentration of a first fluid, and in which a second optical sensor has reflective properties which depend on the concentration of a second fluid which differs from the first fluid.

27. The device of claim 24, wherein a first optical sensor is arranged at a first location, and in which a second optical sensor is arranged at a second location which does not adjoin the first optical sensor.

28. The device of claim 24, wherein a first sensor has reflective properties which change at a first concentration of a fluid, and in which a second sensor has reflective properties which change at a second concentration of the same fluid, which differs from the first concentration.

29. The device of claim 24, wherein the optical sensors have reflective properties which depend on the pH value of the fluid to be detected.

30. The device of claim 29, wherein the optical sensors have reflective properties which depend on the temperature of the fluid to be detected.

31. The device of claim 24, wherein the optical sensors have reflective properties which depend on the presence of elements/compounds in the fluid to be detected.

32. The device of claim 24, wherein the coupling ends of the optical fibres are situated in a common coupling end plane where light can be injected into and can be ejected from the coupling ends.

33. The device of claim 32, wherein the optical body has a straight light-transmitting surface which extends substantially parallel to the coupling end plane, and in which the light source is arranged on a first part of said light-transmitting surface and the detector is arranged on a second part of said light-transmitting surface.

34. The device of claim 33, wherein the light source on the first part of the light-transmitting surface surrounds the detector on the second part of the light-transmitting surface.

35. The device of claim 24, wherein the optical body comprises a light-transmitting material, such as glass or polycarbonate, and wherein the optical body is delimited by surfaces which are covered with a light-absorbing coating, except for at least the light-transmitting surface or the light-transmitting surfaces.

36. The device of claim 24, wherein the optical fibres from the coupling ends are arranged substantially parallel to one another and at a distance from one another in the optical body.

37. The device of claim 24, wherein the device is provided with an image recognition device for automatically recognizing the image, received by the detector of the coupling ends which do or do not eject light reflected by the sensors.

38. A method for optically detecting fluid, comprising:
(a) providing a device comprising (i) several optical fibres, each of which is provided with a sensor end and an opposite coupling end, in which each of the sensor ends is provided with an optical sensor having reflective properties which depend on a property of the fluid to be detected at the sensor, (ii) a light source, (iii) a detector, and (iv) an optical body, wherein the coupling ends of the optical fibres are connected to the optical body at a distance from one another,
(b) conducting light from the light source through the optical body to the coupling ends and coupling the light at the coupling ends,
(c) conducting the coupled light from the coupling ends through the optical fibres to the sensors at the sensor ends,
(d) reflecting amounts of light through the sensors to the sensor ends which depend on said property of the fluid to be detected at the location of the sensors,
(e) conducting the reflected light from the sensor ends through the optical fibres back to the coupling ends,
(f) ejecting the reflected light from the coupling ends and conducting the reflected, ejected light from the coupling ends through the optical body to the detector and said light being received by the detector,
(g) separately detecting the reflected, ejected light from different coupling ends which are situated at a distance from one another.

39. The method of claim 38, wherein the coupling ends of the optical fibres are connected to the optical body in accordance with a pattern, and in which the detector receives the ejected light from each coupling end in an image plane according to a pattern of points of light which corresponds to the pattern of the coupling ends.

40. The method of claim 38, wherein the optical sensors detect different kinds of fluid.

41. The method of claim 38, wherein the optical sensors detect concentrations at different locations.

42. The method of claim 38, wherein the optical sensors detect different concentrations of the same fluid.

43. The method of claim 38, wherein the optical sensors detect the pH value of the temperature.

44. The method of claim 38, wherein the image, received by the detector of the coupling ends is automatically recognized by means of image recognition.
